(19) United States
(12) Patent Application Publication
(10) Pub. No.: US 2020/0333586 A1
(43) Pub. Date: Oct. 22, 2020

(54) IMAGE FORMATION DEVICE

(71) Applicant: MAXELL, LTD., Kyoto (JP)

(72) Inventors: Yasuyuki SHIBAYAMA, Kyoto (JP); Masahiro KISHIGAMI, Kyoto (JP)

(21) Appl. No.: 16/764,537

(22) PCT Filed: Nov. 8, 2018
(86) PCT No.: PCT/JP2018/041535

§ 371 Date: May 15, 2020

(30) Foreign Application Priority Data
Feb. 22, 2018 (JP) 2018-030129

(51) Int. Cl. G02B 26/10; G02B 26/08

(52) U.S. Cl. CPC G02B 26/101; G02B 26/0833

(57) ABSTRACT

An image formation device 1 forms a projection image 3 by projecting a pencil of rays 40 emitted from a light source onto a projection surface 2, the image formation device including a light scanning unit 10 that deflects and reflects the pencil of rays 40 in a first direction and a second direction intersecting with the first direction, and a projection system 9 that guides the deflected and reflected pencil of rays 40 to the projection surface 2. The projection system 9 is configured to allow the optical paths of principal rays 5, 6, 7, and 8 in each pencil of rays 40 incident on the projection system 9 to mutually intersect at a position between an incidence surface 11 and an emission surface 14 of an optical element that makes up the projection system 9.

### TECHNICAL FIELD

The present invention relates to an image formation technique for forming a projection image. More specifically, the present invention relates to an image formation technique that enables ultra-close-range projection.

### BACKGROUND ART

There is a small image projection device that two-dimensionally deflects and scans light from a light source to project an image.

For example, Patent Literature 1 discloses a projection type display optical system that is “a projection type display optical system P having light deflection means for deflecting and scanning light, and a projection optical system for projecting the light from the light deflection means, in which the position or tilting of an image formed by the projection light from the projection optical system is variable (excerpted abstract)”.

Also, Patent Literature 2 discloses a laser projection device that is “a laser projection device including laser elements, incidence optical systems on which luminous fluxes from the respective laser elements are incident, a scanning device for two-dimensionally scanning the luminous fluxes, a projection optical system for projecting the luminous fluxes from the scanning device onto a screen, and the like, in which the scanning device includes a resonance driving mirror for performing deflection in a main scanning direction, in which a light source image is formed at least once in an optical path from the scanning device to the screen, in which the projection optical system includes reflection mirrors, and is designed so that with respect to the main scanning direction, the positive power is stronger toward the periphery in the main scanning direction, and in which in the incidence optical systems, the power in the main scanning direction and the power in a sub-scanning direction are different from each other (excerpted abstract)”.

Also, Patent Literature 3 discloses a light scanning device that is “a light scanning device that has light source means, deflection means for deflecting a luminous flux emitted from the light source means in two-dimensional directions that are a first scanning direction and a second scanning direction orthogonal thereto, and a scanning optical system for guiding the luminous flux deflected by the deflection means onto a scanning surface, and performs light scanning on the scanning surface by the deflection operation of the deflection means, in which the deflection means has a deflector that is sine wave driven in the first scanning direction, and in which one optical surface configuring the scanning optical system has a shape in which a second order differential value in the first scanning direction is changed in α direction in which the deflection luminous flux is diverged, from the center toward the periphery in the first scanning direction, the shape being joined to the second scanning direction (excerpted abstract)”.

Also, Non-Patent Literature 1 discloses a phenomenon in which particles such as dust are likely to be tapped in a high light density region.

### CITATION LIST

### Patent Literature

PATENT LITERATURE 1: Japanese Patent Application Laid-Open No. 2004-252012
PATENT LITERATURE 2: Japanese Patent Application Laid-Open No. 2008-164957
PATENT LITERATURE 3: Japanese Patent Application Laid-Open No. 2006-178346

### Non-Patent Literature

NON-PATENT LITERATURE 1: Ashkin et al.: Observation of a single-beam gradient force optical trap for dielectric particles. Opt. Lett. 11, P288-P290, 1986

### SUMMARY OF INVENTION

### Technical Problem

In the projection type image formation device, the angle of view becomes larger with the closer-range projection in which the distance from the image formation device to the projection surface is shorter. Therefore, when, like the image formation device described in Patent Literature 3, the principal ray in the pencil of rays directed toward the outer periphery of the projection image is of the diverging type, the size of the projection optical system becomes larger as well.

In the projection optical systems disclosed in Patent Literature 1 and Patent Literature 2, the principal ray in the pencil of rays directed toward the outer periphery of the projection image are intersected in front of the projection surface. However, the intersection position is somewhere between the final emission surface of the projection optical system and the projection surface, that is, outside the device. The light energy density is typically high at the intersection position, so that when the intersection position is outside the device, and for example, the user accidently brings his/her face closer to and looks into the luminous flux, the incidence light energy into his/her eyeballs is large.

For this reason, the intersection position of the principal ray is desirably inside the projection optical system, but when the intersection position is near the optical surface, as disclosed in Non-Patent Literature 1, the optical surface is likely to be dirt which leads to the deterioration of the projection image.

The present invention has been made in view of the above problems, and an object of the present invention is to provide an image formation technique including close-range projection capable of safely forming a high-quality projection image without increasing the size of a device.

### Solution to Problem

To achieve the above object, an image formation device of the present invention is an image formation device that forms a projection image by projecting a pencil of rays emitted from a light source onto a projection surface, the image formation device including a light scanning unit that deflects and reflects the pencil of rays in a first direction and a second direction intersecting with the first direction, and a projection system that guides the deflected and reflected pencil of rays to the projection surface. The projection system is configured to allow the optical paths of principal rays in each pencil of ray incident on the projection system to mutually intersect at a position between an incidence surface and an emission surface of an optical element that makes up the projection system.

### Advantageous Effects of Invention

According to the present invention, it is possible to provide the image formation technique including close-range projection capable of safely forming the high-quality projection image without increasing the size of the device. Other objects, configurations, and effects of the present invention will be apparent in the following description.

### BRIEF DESCRIPTION OF DRAWINGS

FIG. 1A and FIG. 1B are explanatory views for explaining the using state of an image formation device of an embodiment of the present invention.

FIG. 2A and FIG. 2B are respectively a block diagram and a hardware configuration diagram of the image formation device of the embodiment of the present invention.

FIG. 3 is an explanatory view for explaining a light source of the embodiment of the present invention.

FIG. 4 is an explanatory view for explaining a pre-scanning optical system of the embodiment of the present invention.

FIG. 5 is an explanatory view for explaining a scanning unit of the embodiment of the present invention.

FIG. 6A and FIG. 6B are respectively explanatory views for explaining a driving waveform of a light scanning unit of the embodiment of the present invention.

FIG. 7 is an explanatory view for explaining a ray deflected and reflected by the mirror surface of the light scanning unit of the embodiment of the present invention.

FIG. 8A and FIG. 8B are explanatory views for explaining a projection system of the embodiment of the present invention.

FIG. 9A is an explanatory view for explaining paths of rays inside the projection system of the embodiment of the present invention; and FIG. 9B is an enlarged view of part of FIG. 9A.

FIG. 10A is an explanatory view for explaining the paths of the rays inside the projection system of the embodiment of the present invention; and FIG. 10B is an enlarged view of part of FIG. 10A.

FIG. 11 is a table illustrating the position relationships in an optical system of the embodiment of the present invention.

FIG. 12 is an explanatory view for explaining the relationships between the xyz coordinate system and the local coordinate system of the embodiment of the present invention.

FIG. 13 is a table of each coefficient of an aspherical polynomial equation identifying each surface shape of the optical system of the embodiment of the present invention.

FIG. 14 is an explanatory view for explaining the distortion performances of a projection image formed by the image formation device of the embodiment of the present invention.

FIG. 15 is an explanatory view for explaining the image forming performances of the projection image illustrated in FIG. 14.

### DESCRIPTION OF EMBODIMENT

An embodiment of the present invention will be described below with reference to the drawings.

An image formation device of this embodiment is a device for projecting an image onto a projection surface by two-dimensional scanning of light, and is applicable to, for example, an image projection device such as a pocket projector, a data projector, a projection television, and an in-vehicle display device.

<Using Examples of the Image Formation Device>

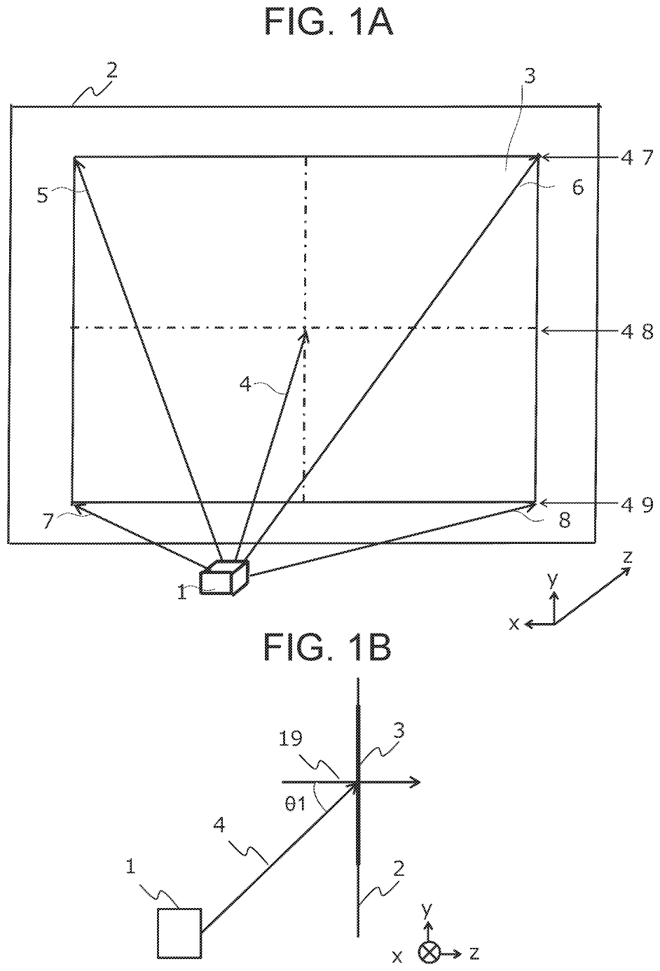

First, the using states of the image formation device of this embodiment will be described. FIG. 1A and FIG. 1B are diagrams illustrating the using states of an image formation device 1 of this embodiment.

The image formation device 1 of this embodiment is disposed to face a projection surface 2, and projects light onto the projection surface 2 to form a projection image 3 on the projection surface 2. In FIG. 1A, the reference numeral 4 denotes a principal ray in a pencil of rays directed toward the center of the projection image 3, the reference numeral 5 denotes a principal ray in the pencil of rays directed toward the upper left corner of the projection image 3, the reference numeral 6 denotes a ray in the pencil of rays directed toward the upper right corner of the projection image 3, the reference numeral 7 denotes a principal ray in the pencil of rays directed toward the lower left corner of the projection image 3, and the reference numeral 8 denotes a principal ray in the pencil of rays directed toward the lower right corner of the projection image 3, respectively. Also, the reference numeral 47 denotes the upper side of the projection image 3, the reference numeral 48 denotes the center in the height direction of the projection image 3, and the reference numeral 49 denotes the lower side of the projection image 3.

Hereinafter, in this embodiment, a coordinate system in which the direction of a normal line 19 of the projection surface 2 is a z-axis direction, the long direction of the projection image 3 is an x-axis direction, and the short direction of the projection image 3 is a y-axis direction will be used. It should be noted that the projection image 3 has a rectangular shape, the left-right direction (the width direction, the x-axis direction) is called the long direction, and the up-down direction (the height direction, the y-axis direction) is called the short direction.

Also, the rotation about the x-axis is a rotation, the rotation about the y-axis is 0 rotation, the rotation about the z-axis is γ rotation, and the origin point of the xyz coordinate system is the center of the mirror surface of a light scanning unit 10 described later.

It should be noted that as illustrated in FIG. 1B, in this embodiment, the projection surface 2 is disposed in parallel with the xy plane, and the principal ray 4 is parallel with the yz plane, and is incident on the projection surface 2 at a tilt angle θ1 with respect to the normal line of the projection surface 2.

<Configuration of the Image Formation Device>

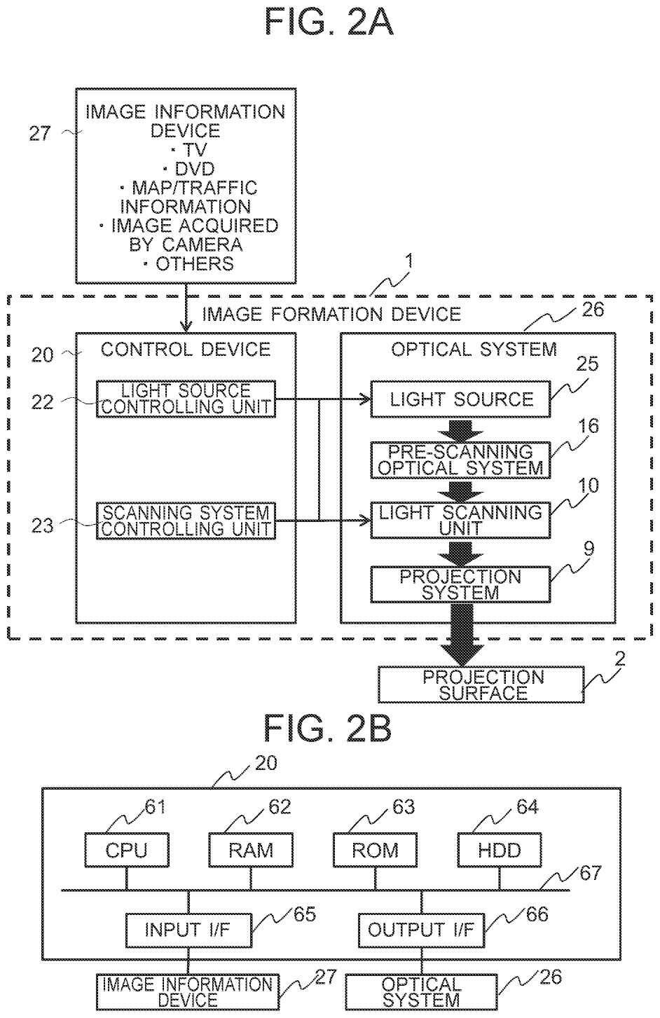

Next, the configuration of the image formation device 1 of this embodiment will be described. FIG. 2A is a block diagram of the entire configuration of the image formation device 1 of this embodiment.

The image formation device 1 of this embodiment includes a control device 20 and an optical system 26. And, the image formation device 1 projects, onto the projection surface 2, an image acquired from an image information device 27 connected to the image formation device 1.

It should be noted that the image information device 27 is a device that holds an image signal that is the origin of the projection image 3 formed on the projection surface 2 by the image formation device 1 (an original image signal). The original image signal is, for example, amusement information of a television (TV), a DVD, and the like, a map, traffic information, an image signal acquired by an external camera, and the like. The image information device 27 outputs the original image signal that it holds, to the image formation device 1.

<<Control Device>>

The control device 20 controls the optical system 26 on the basis of the original image signal received from the image information device 27. According to this control, light is emitted from the optical system 26 toward the projection surface 2, and the light reaching the projection surface 2 is scanned on the projection surface 2 while being modulated, so that the projection image 3 is formed on the projection surface 2.

To achieve this, the control device 20 includes a light source controlling unit 22 and a scanning system controlling unit 23.

The light source controlling unit 22 generates a modulation signal on the basis of the original image signal inputted from the image information device 27 to drive a light source, thereby controlling the light amount of the light outputted from the light source. With this, the unevenness of the brightness at each projection position of the projection light forming the projection image 3 can be prevented.

The scanning system controlling unit 23 corrects the distortion and the color distortion that cannot be completely corrected by the optical system 26 on the basis of the original image signal inputted from the image information device 27, and controls a light source 25 and the light scanning unit 10 by the image signal after correction. The details of the control of the light scanning unit 10 will be described later.

The light amount and the distortion of the projection image 3 may be corrected by generating correction data on the basis of the data calculated from optical performance. Also, the light amount and the distortion of the projection image 3 may be corrected by imaging the projection image 3 by the camera and generating correction data on the basis of the data of the acquired imaged image.

FIG. 2B is a hardware configuration diagram of the control device 20. In this embodiment, the control device 20 includes a CPU (Central Processing Unit) 61, a RAM (Random Access Memory) 62, a ROM (Read Only Memory) 63, an HDD (Hard Disk Drive) 64, an input I/F 65, and an output I/F 66. The control device 20 is configured such that these are connected to each other via a bus 67. Each portion of the control device 20 is achieved in such a manner that the CPU 61 loads the program that is previously stored in the ROM 63 and the like to the RAM 62, and executes it.

The image information device 27 is connected to the input I/F 65, so that the original image signal is inputted. Also, the optical system 26 is connected to the output I/F 66, so that a processing result and a control signal are outputted. For example, the scanning system controlling unit 23 outputs the control signal to the light source 25 and the light scanning unit 10 of the optical system 26 described later, and controls the operation of the light source 25 and the light scanning unit 10.

It should be noted that the hardware configuration of the control device 20 is not limited to the above, and may be configured of a combination of a control circuit and a storage device.

<<Optical System>>

The optical system 26 emits light onto the projection surface 2 according to the control of the control device 20, and forms the projection image 3 on the projection surface 2. To achieve this, the optical system 26 includes the light source 25, a pre-scanning optical system 16, the light scanning unit 10, and a projection system 9.

<Light Source>

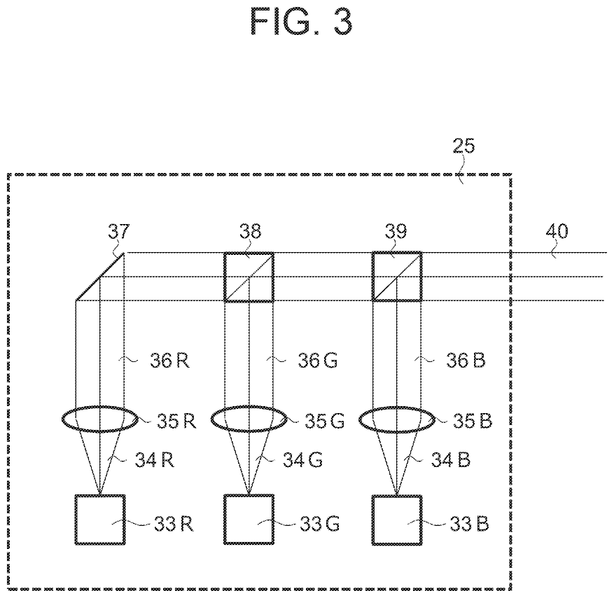

The light source 25 emits a pencil of rays through the pre-scanning optical system 16 to the light scanning unit 10 according to an instruction from the control device 20. FIG. 3 is a diagram of an example of the configuration of the light source 25.

As illustrated in this drawing, the light source 25 includes a laser light source 33R that generates R (red) light, a laser light source 33G that generates G (green) light, and a laser light source 33B that generates B (blue) light. Pencils of rays 34R, 34G, and 34B emitted from the respective laser light sources are shaped by lenses 35R, 35G, and 35B to pencils of rays 36R, 36G, and 36B that are substantially parallel lights, respectively. The distance between the laser light source 33R and the lens 35R, the distance between the laser light source 33G and the lens 35G, and the distance between the laser light source 33B and the lens 35B are slightly adjusted so that the difference in the focusing states of the respective laser beams on the projection surface 2 is reduced.

In FIG. 3, the reference numeral 37 denotes a mirror, the reference numeral 38 denotes a color synthesis element having a characteristic that transmits the red light and reflects the green light, and the reference numeral 39 denotes a color synthesis element having a characteristic that transmits the red light and the green light and reflects the blue light. By the mirror 37, the color synthesis element 38, and the color synthesis element 39, the pencils of rays 36R, 36G, and 36B become a pencil of rays 40 that is acquired by coaxially synthesizing them, which is then emitted from the light source 25. The pencil of rays 40 emitted from the light source 25 is directed toward the pre-scanning optical system 16.

The color synthesis elements 38 and 39 are configured of, for example, a combination of a prism and a dichroic mirror. The size of the pencil of rays 40 is set to 01 to 3 mm.

The laser light source 33R includes, for example, a semiconductor laser that generates the light having a wavelength of 630 nm. The laser light source 33G includes, for example, a diode pumped solid-state laser that generates the light having a wavelength of 532 nm by using second harmonic generation. The laser light source 33B includes, for example, a semiconductor laser that generates the light having a wavelength of 445 nm. By appropriately setting each laser light source, the projection image can be a sharp image having fine white color and wide color reproducibility.

Each laser light source may be modulated by changing an injection current to a laser chip and an injection current to an exciting laser chip, or may be modulated by using an external optical modulator separately from the laser light source. As the external optical modulator, there are an acousto-optic modulator, an electro-optic modulator, and the like.

It should be noted that FIG. 3 illustrates a case where the number of each of the respective color laser light sources is one, but the number of laser light sources is not limited to this. Each of the color laser light sources may use one or more light sources to configure the light source 25. A brighter projection image can be formed by increasing the number of light sources synthesized.

<Pre-Scanning Optical System>

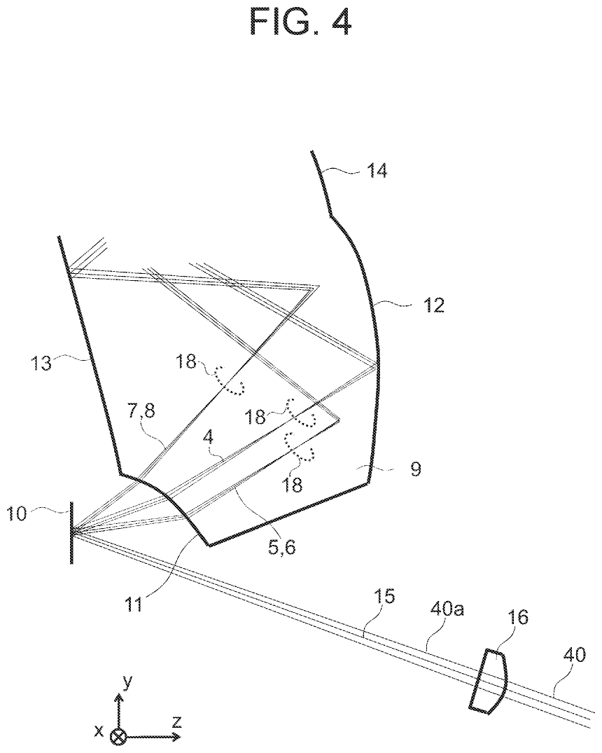

As illustrated in FIG. 4, in the pre-scanning optical system 16, the pencil of rays 40 emitted from the light source 25 is convergence light 40a, which is inputted to the light scanning unit 10. The pre-scanning optical system 16 includes, for example, a plano-convex spherical lens. The inputted pencil of rays 40 becomes the focusing light (the convergence light) by this spherical lens. The spherical lens used for the pre-scanning optical system 16 is molded of, for example, a resin in which nd is 1.5312 and νd is 56.0. It should be noted that each portion illustrated in FIG. 4 will be described later.

Here, a case where the pre-scanning optical system 16 includes the spherical lens is illustrated, but the pre-scanning optical system 16 is not limited to this. The pre-scanning optical system 16 may only allow the pencil of rays 40 emitted from the light source 25 to be the convergence light 40a, and may include, for example, a lens having an anamorphic lens such as a cylinder lens, a toroidal lens, and other aspherical lenses.

<Light Scanning Unit>

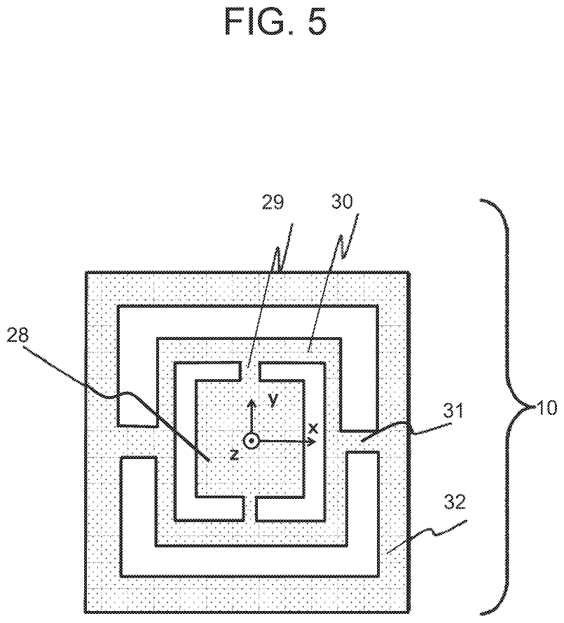

The light scanning unit 10 performs the scanning by deflecting and reflecting the pencil of rays 40 (the convergence light 40a) emitted from the light source 25 and passed through the pre-scanning optical system 16. FIG. 5 is an enlarged view of an example of the light scanning unit 10.

As illustrated in this drawing, the light scanning unit 10 includes a mirror 28 that is a reflection surface and a driving unit that drives the mirror 28. The mirror 28 is driven by the driving unit to deflect and reflect the light from the light source 25 (laser beam; the pencil of rays 40). The size of the mirror 28 is, for example, 1 to 1.5 mm.

The driving unit includes a first torsion spring 29 coupled to the mirror 28, a holding member 30 coupled to the first torsion spring 29, a second torsion spring 31 coupled to the holding member 30, a holding member 32 coupled to the second torsion spring 31, and a permanent magnet, a coil, and the like, which are not illustrated. In this embodiment, the scanning system controlling unit 23 controls the electric current flowed to the coil to control the driving unit, and as a result, operates the mirror 28.

The coil is formed to be substantially parallel with the mirror 28. When the mirror 28 is in a stationary state, the permanent magnet is disposed to generate a magnetic field that is substantially parallel with the mirror 28. When the electric current is flowed to the coil, the Lorentz force that is substantially perpendicular to the surface of the mirror 28 is generated by Fleming's left hand rule. The mirror 28 is rotated to the position where the Lorentz force and the restoring force of the first torsion spring 29 and the second torsion spring 31 are balanced.

An alternating current is supplied to the coil at the resonant frequency that the mirror 28 has, so that the mirror 28 performs resonance operation, and is rotated about the first torsion spring 29 (the β rotation). Also, an alternating current is supplied to the coil at the resonant frequency that a portion combining the mirror 28 and the holding member 30 has, so that the mirror 28, the first torsion spring 29, and the holding member 30 perform the resonance operation, and are rotated about the second torsion spring 31 (the α rotation). In this way, for the two directions, the resonance operation according to the different resonant frequencies is achieved. It should be noted that in place of the resonance operation according to the resonant frequencies, driving that is not the resonance operation may be applied.

For the light scanning unit 10 as described above, for example, a MEMS (Micro Electro Mechanical Systems) mirror is used. By using the MEMS mirror, two-dimensional scanning can be performed by the single scanning device, so that the number of components can be reduced, and the assembling and the adjusting cost can be reduced. Also, as compared with a case of using a galvano mirror, the image formation device 1 is smaller, more lightweight, and more compact, the higher-speed deflection is also enabled, so that an increase in resolution of the projection image 3 is enabled.

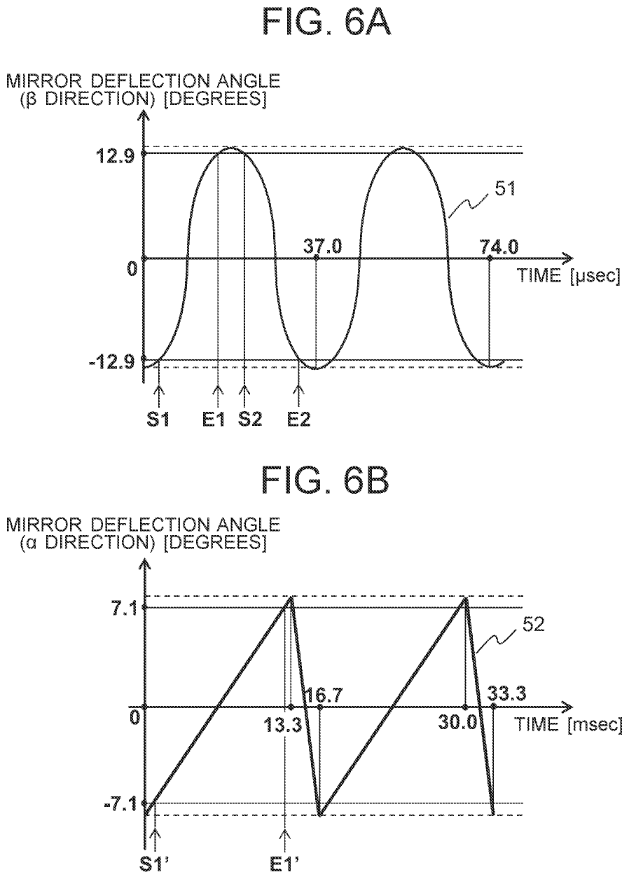

Referring to FIG. 6A and FIG. 6B, driving waveforms of the mirror 28 will be described. FIG. 6A is a diagram illustrating a driving waveform of the first torsion spring 29 of the light scanning unit 10. FIG. 6B is a diagram illustrating a driving waveform of the second torsion spring 31 of the light scanning unit 10.

By the electric current supply control from the scanning system controlling unit 23, the light scanning unit 10 of this embodiment allows the mirror 28 to make the reciprocating rotational movement in each of the direction in which the first torsion spring 29 is the rotation axis and the direction in which the second torsion spring 31 is the rotation axis.

Specifically, as illustrated in FIG. 6A, the light scanning unit 10 drives the mirror 28 in a sine waveform (the effective deflection angle: ±12.9 degrees, the cycle: 37.0 μsec) in the direction in which the first torsion spring 29 is the rotation axis (the β direction). Also, as illustrated in FIG. 6B, the light scanning unit 10 drives the mirror 28 in a sawtooth waveform (the effective deflection angle: ±7.1 degrees, the cycle: 16.7 msec) in the direction in which the second torsion spring 31 is the rotation axis (the α direction).

It should be noted that the effective deflection angle is, among the deflection angles of the mirror 28, the maximum angle that performs the image formation. Also, the “deflection” in this case is not related to the presence or absence of the beam and the traveling direction of the light, and simply means that the direction of the mirror surface (or the normal line of the mirror surface) is changed.

According to a driving waveform 51 illustrated in FIG. 6A, the mirror 28 is rotated in the β direction, and the light deflected and reflected by the mirror 28 is scanned on the projection surface 2 in the x-axis direction. Also, according to a driving waveform 52 illustrated in FIG. 6B, the mirror 28 is rotated in the α direction, and the light deflected and reflected by the mirror 28 is scanned on the projection surface 2 in the y-axis direction.

In FIG. 6A, S1 is the scanning start time of one scanning that forms the projection image, and E1 is the scanning end time of the one scanning that forms the projection image. The mirror 28 makes the reciprocating rotational movement. The time from the S1 to the E1 is the scanning time of the forward path of the one scanning, and the time from S2 to E2 is the scanning time of the return path of the one scanning (the second scanning line). The time from S1′ to E1′ in FIG. 6B is the time until all the scanning lines of the projection image are formed, and this is the time required for forming one image. That is, 16.7 [msec] that is one cycle of the driving waveform 52 is the time required for drawing one image in the image formation device 1 of this embodiment.

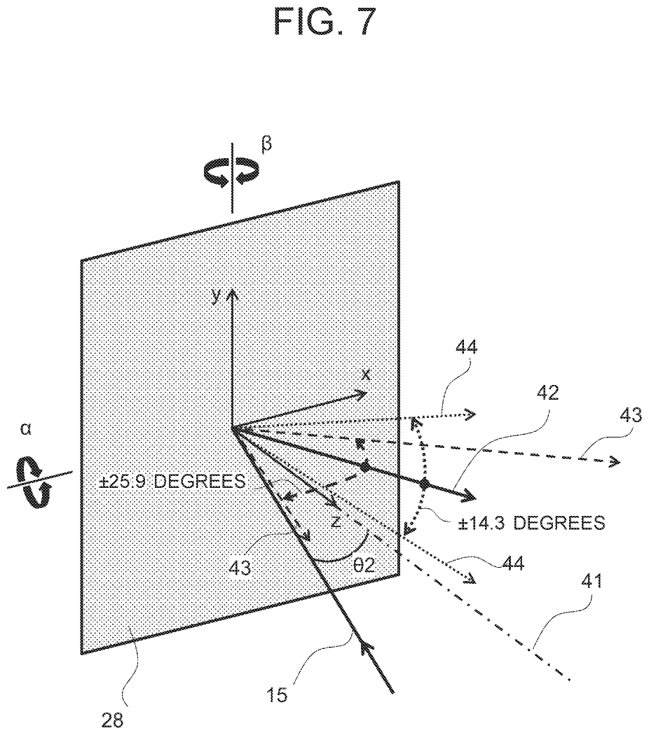

FIG. 7 is a diagram for explaining a state where a beam incident on the mirror 28 of the light scanning unit 10 is deflected and reflected by the mirror 28 and is two-dimensionally scanned. The beam incident on the mirror 28 is actually the pencil of rays 40 emitted from the light source 25 (the convergence light 40a), but here, to avoid complexity, only a beam that is a principal ray 15 in the pencil of rays 40 (the convergence light 40a) is illustrated.

The mirror 28 is in a reference state when the deflection angle is zero. The beam (the principal ray 15) incident on the mirror 28 is incident on the mirror surface from the direction having a tilt angle θ2 with respect to a normal line 41 of the mirror surface in the yz plane. The reference numeral 42 in the drawing denotes a reflection ray acquired by reflecting the incident principal ray 15 by the mirror 28 when the mirror 28 is in the reference state. Also, in the drawing, the reference numeral 43 denotes the track of the ray deflected and reflected by the rotation in the β direction of the mirror 28, and the reference numeral 44 denotes the track of the ray deflected and reflected by the rotation in the α direction of the mirror 28.

As illustrated in this drawing, since the effective deflection and reflection angle of the principal ray 15 is twice the effective deflection angle of the mirror 28, it is ±25.9 degrees in the β direction, and is the ±14.3 degrees in the α direction.

As described above, the mirror 28 of the light scanning unit 10 is driven in the sine waveform in the β direction and in the sawtooth waveform in the α direction, so that even when the light reflected by the mirror 28 is illuminated onto the projection surface 2 as it is, the scanning speed of the light that scans the projection surface 2 is not a uniform speed. Accordingly, to ensure the uniform speed properties, the light is projected onto the projection surface 2 through the projection system 9 having an f arc sine characteristic in the x direction and an f-O characteristic in the y direction.

<Projection System>

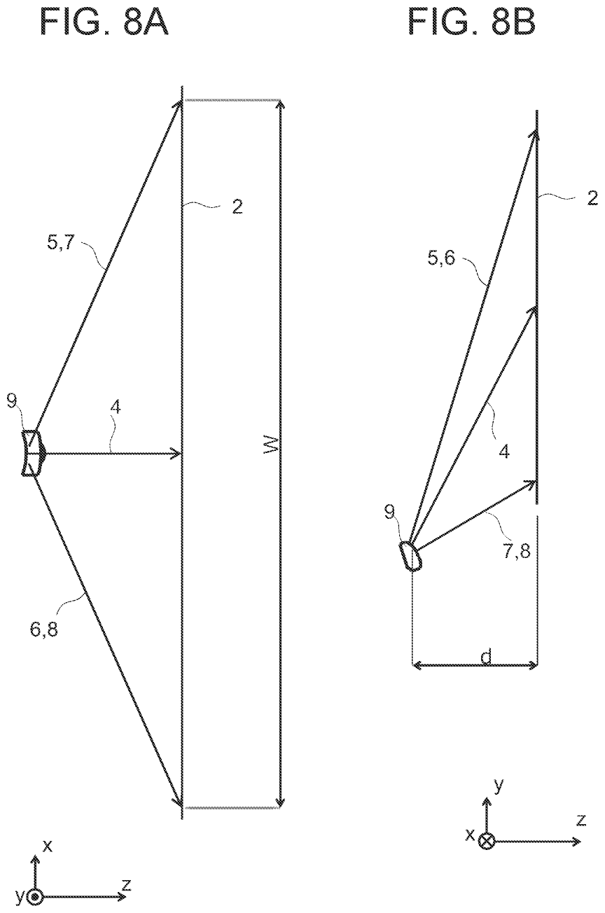

Next, the projection system 9 will be described. As illustrated in FIG. 8A and FIG. 8B, the projection system 9 guides the light (the pencil of rays) deflected and reflected by the light scanning unit 10 to the projection surface 2, and allows the light to be image formed. Any of the deflection angles of the light deflected by the mirror 28 of the light scanning unit 10 is enlarged by the projection system 9, and is converted to the angle of view. In the image formation scanning on the projection surface 2, the light is modulated to form the projection image 3 on the projection surface 2.

It should be noted that FIG. 8A is a diagram in which the principal ray 15 directed from the image formation device 1 toward the projection surface 2 is seen from the xz cross section, and FIG. 8B is a diagram in which the principal ray 15 directed from the image formation device 1 toward the projection surface 2 is seen from the yz cross section. However, to avoid complexity, FIG. 8A and FIG. 8B illustrate only the portion from the projection system 9 to the projection surface 2.

The projection system 9 of this embodiment has a plurality of transmission units and of reflection units, and is configured so that the pencil of rays 40 is reflected inside at least twice, and then is exited from the projection system 9. Also, the optical paths of the principal rays 15 in each pencil of rays 40 that are scanned by the light scanning unit 10 and are incident are intersected inside the projection system 9.

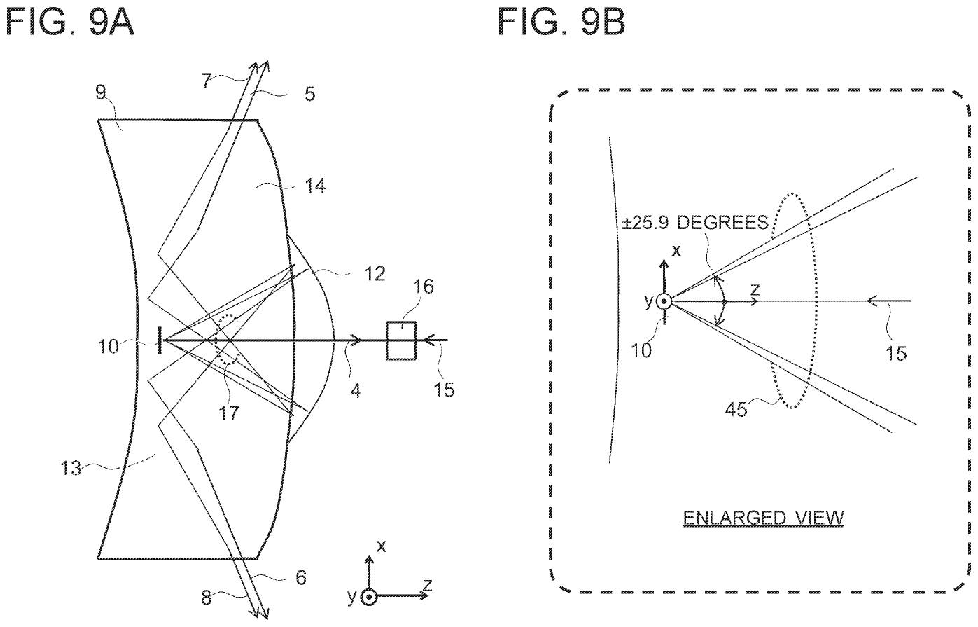

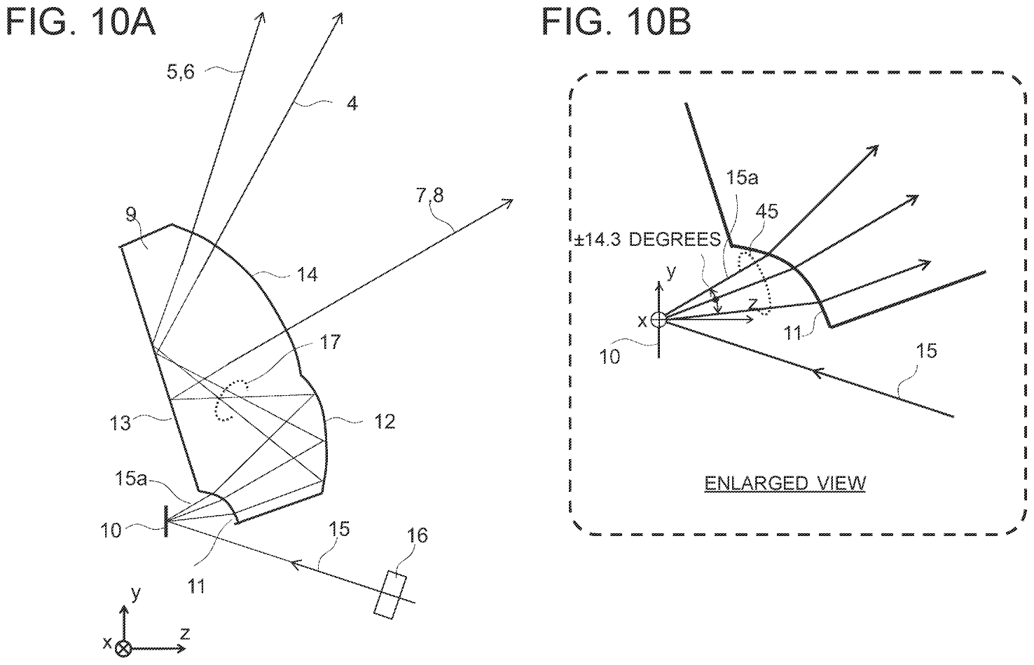

The state of the propagation of this ray in the projection system 9 of this embodiment will be described with reference to FIG. 9A, FIG. 9B, FIG. 10A, and FIG. 10B.

FIG. 9A is a diagram illustrating the path of the principal ray 15 and the paths of the rays incident on and reflected by the light scanning unit 10 in the cross section of the projection system 9 in FIG. 8A, and FIG. 10A is a diagram illustrating the path of the principal ray 15 and the paths of the rays incident on and reflected by the light scanning unit 10 in the cross section of the projection system 9 in FIG. 8B. Also, FIG. 9B is a diagram further enlarging the position portion of the light scanning unit 10 in FIG. 9A, and FIG. 10B is a diagram further enlarging the position portion of the light scanning unit 10 in FIG. 10A.

As described previously, the light that is emitted from the light source 25 and is incident on the light scanning unit 10 through the pre-scanning optical system 16 is the pencil of rays 40. However, to avoid complexity, also in FIG. 9A, FIG. 9B, FIG. 10A, and FIG. 10B, only the optical path of the principal ray 15 in the pencil of rays 40 is illustrated. As described above, the effective deflection and reflection angle of the principal ray 15 is ±25.9 degrees in the β direction, and is ±14.3 degrees in the α direction.

As illustrated in FIG. 9A and FIG. 10A, the projection system 9 of this embodiment includes, for example, a single optical element having two independent transmission units (an incidence surface 11 and an emission surface 14) and two independent reflection units (a first reflection surface 12 and a second reflection surface 13). This optical element is molded of, for example, a resin in which nd (refractive index) of 1.532 and νd (Abbe number) is 56.0. Also, the reflection members are coated on the first reflection surface 12 and the second reflection surface 13 to form the mirror surfaces.

As illustrated in FIG. 10A, principal rays 15a deflected and reflected by the light scanning unit 10 are first incident from the incidence surface 11 into the projection system 9, are then reflected by the first reflection surface 12 and the second reflection surface 13 in that order, and are passed through the emission surface 14 to be exited from the projection system 9.

The principal ray 15 incident on the light scanning unit 10 is deflected and reflected by the mirror 28. Among the deflected and reflected principal rays 15a, the principal rays directed toward the outer periphery of the projection image 3 become divergence rays centered on the mirror 28 (the reference numeral 45 in FIG. 9B and FIG. 10B).

As described above, the projection system 9 of this embodiment is configured so that the respective principal rays 45 diverged are focused inside the projection system 9 once. That is, the projection system 9 of this embodiment is configured so that the optical paths of the respective principal rays 45 are intersected inside the projection system 9. The inside of the projection system 9 is the position between the incidence surface 11 and the emission surface 14. In this embodiment, in particular, the optical paths of the respective principal rays 45 are intersected at a position between the first reflection surface 12 and the second reflection surface 13.

Hereinafter, the position where the optical paths of the respective principal rays 45 are intersected will be called a focusing position herein. In FIG. 9A and FIG. 10A, a position 17 is the focusing position of the respective principal rays 45.

Also, as further illustrated in FIG. 4, the optical system 26 of this embodiment is configured so that the respective rays in the pencil of rays emitted from the light source 25 and passed through the pre-scanning optical system 16 to be the convergence light 40a are converged inside the projection system 9 per pencil of rays. The position where the respective rays configuring each pencil of rays are converged is called a converging position. The converging position is indicated by the reference numeral 18 in the drawing.

Next, an example of a specific specification achieving the optical system 26 of this embodiment having the respective characteristics described above, that is, those in which the optical paths of the respective principal rays 45 in the pencil of rays 40 are intersected inside the projection system 9, and the respective rays configuring the pencil of rays 40 (the convergence light 40a) are converged inside the projection system 9 will be described below.

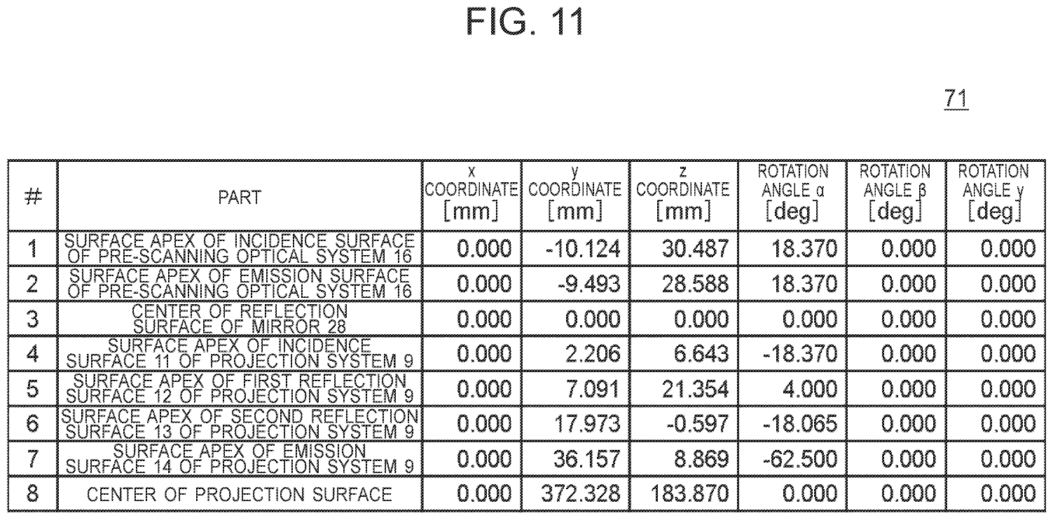

As the specific specification, an example of the position relationship of each surface of the pre-scanning optical system 16, the light scanning unit 10, and the projection system 9 is illustrated in a table 71 in FIG. 11. The table 71 illustrates the position of each surface and the tilting of each surface. It should be noted that the table 71 in FIG. 11 is an example of a case where the image size of the projection image 3 on the projection surface 2 is 40 inches (a full lateral width of 885.6 mm×a full longitudinal width of 498.2 mm).

First, the table 71 illustrates, as the positions of the respective surfaces, the coordinate values (x, y, z) in the xyz coordinate system of the surface apex of the incidence surface of the focusing lens configuring the pre-scanning optical system 16, the surface apex of the emission surface of the focusing lens configuring the pre-scanning optical system 16, the surface center of the reflection surface of the mirror 28 of the light scanning unit 10, the surface apex of the incidence surface 11 of the projection system 9, the surface apex of the first reflection surface 12 of the projection system 9, the surface apex of the second reflection surface 13 of the projection system 9, the surface apex of the emission surface 14 of the projection system 9, and the surface center of the projection surface.

As described previously, the origin of the xyz coordinate system used here is the center of the mirror 28 of the light scanning unit 10, and the direction of the z axis is the direction of the normal line of the projection surface 2. It should be noted that in the example of the table 71, the direction of the normal line of the mirror 28 and the direction of the normal line of the projection surface 2 when the mirror 28 is in the reference state (the deflection angle is zero) are the same direction, and the direction of the z-axis is also the normal line direction of the mirror 28 when the mirror 28 is in the reference state (the deflection angle is zero).

The table 71 also illustrates the values of the rotation angles (α, β, γ) of each surface. The rotation angles (α, β, γ) are the rotation angles about the respective axes of the xyz coordinate system, and the direction of rotation of the right-hand screw is positive.

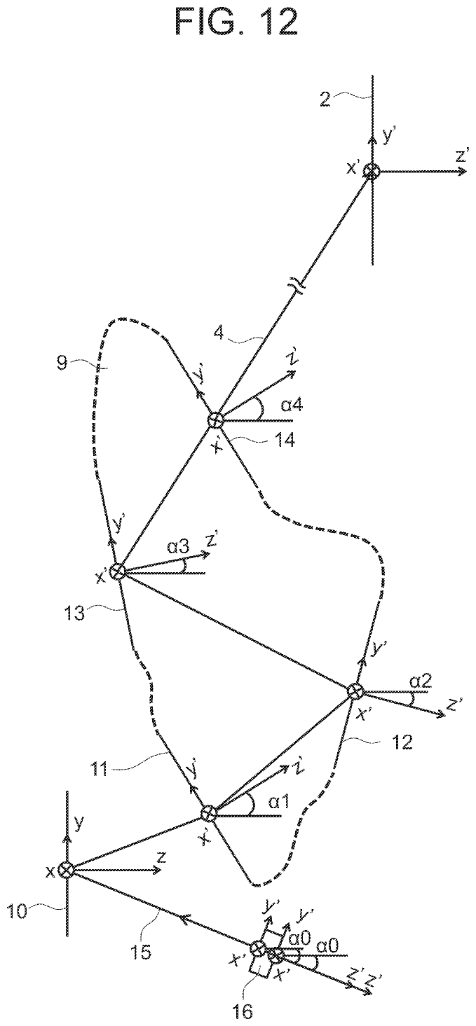

FIG. 12 schematically illustrates the relationship between the global coordinate system (the xyz coordinate system) taken at the center of the reflection surface of the mirror 28 of the light scanning unit 10 and the local coordinate system (the x′y′z′ coordinate system) of the respective surfaces. In the x′y′z′ coordinate system, the xyz coordinate system is first shifted to the respective coordinate positions of the xyz illustrated in the table 71, and the coordinate system is then rotated in the order of α, θ, and γ, so that the x-axis is an x′-axis, the y-axis is a y′-axis, and the z-axis is a z′-axis. However, since both the β and the γ are zero in the table 71, the rotation about the y-axis and the rotation about the z-axis do not occur.

In FIG. 12, α0 is the rotation amount of the incidence surface and the emission surface of the pre-scanning optical system 16 (the rotation angle α), and from the table 71, α0=18.370 degrees. Likewise, α1 is the rotation amount of the incidence surface 11 of the projection system 9 (the rotation angle α), and α1=−18.370 degrees. α2 is the rotation amount of the first reflection surface of the projection system 9 (the rotation angle α), and α2=4.000 degrees. α3 is the rotation amount of the second reflection surface of the projection system 9 (the rotation angle α), and α3=−18.065 degrees. α4 is the rotation amount of the emission surface 14 of the projection system 9 (the rotation angle α), and α4=−62.500 degrees. The rotation amount of the coordinate system of the projection surface 2 (the rotation angle α) is zero.

The shape of each surface is expressed by the following aspherical polynomial equation (1) by using the respective values of the local coordinate system (the x′y′z′ coordinate system).

$$[ Equation 1 ]$$

$${z}^{′} ( {x}^{′} , {y}^{′} ) = \frac{c \cdot ( {x}^{′2} + {y}^{′2} )}{1 + \sqrt{1 - ( 1 + K ) \cdot {c}^{2} \cdot ( {x}^{′2} + {y}^{′2} )}} + Σ \{ {C}_{j} ( m , n ) \cdot {x}^{′ m} \cdot {y}^{′ n} \} \\ c = \frac{1}{R} , j = \frac{[ {( m + n )}^{2} + m + 3 n ]}{2} + 1 \qquad ( 1 )$$

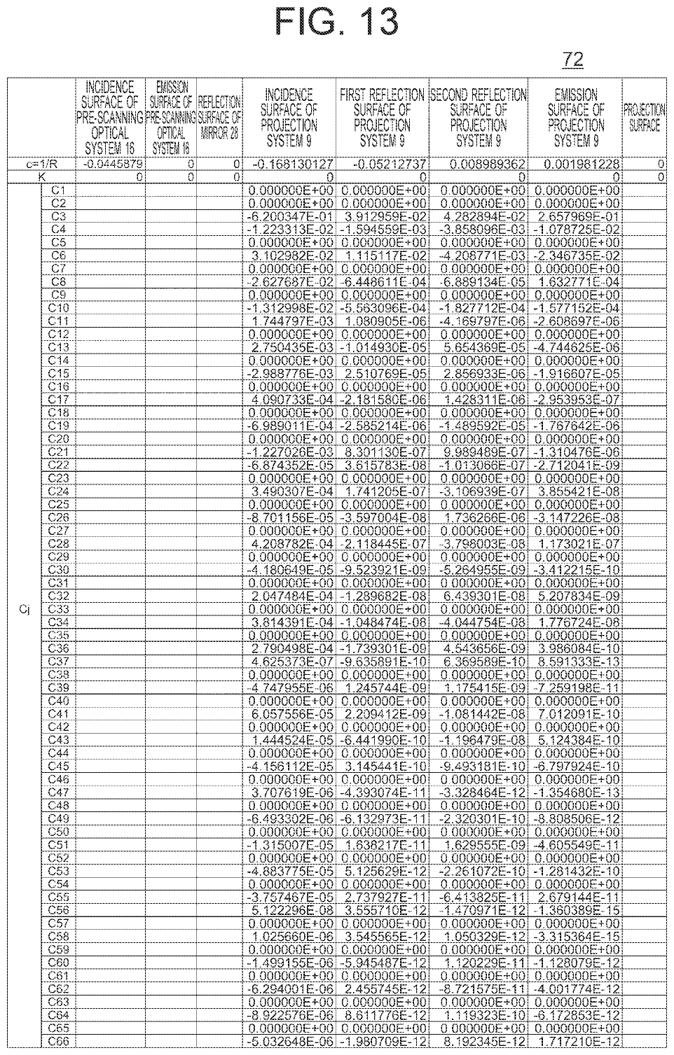

Here, z′ is the sag amount (profile) of each surface, R is the curvature radius of each surface, K is a conic constant, and Cⱼ (m,n) is an aspherical coefficient. Also, c (center curvature 1/R), the conic constant K, and the aspherical coefficient Cj (j=1 to 66) are illustrated in a table 72 in FIG. 13.

As illustrated in the table 72, in the ray path of the principal ray 4 passed through the mirror 28 and the projection system 9 and directed toward the center of the projection image 3, the powers (refracting powers) of the respective surfaces that are the incidence surface 11, the first reflection surface 12, the second reflection surface 13, and the emission surface 14 of the projection system 9 are negative, positive, positive, and positive in that order.

As described above, in the image formation device 1 of this embodiment, the principal rays 45 deflected, reflected, and diverged by the light scanning unit 10 are focused inside the projection system 9. According to this embodiment, in this way, the principal rays 45 diverged are intersected, so that the size of the projection system 9 can be prevented from being increased, and with this, the miniaturization of the entire image formation device 1 can be achieved.

Further, this intersection position (the focusing position 17) is inside the projection system 9. Thus, a region in which the light energy density is high is also inside the projection system 9. Therefore, the safe image formation device 1 can be achieved.

Further, according to this embodiment, as described above, the focusing position 17 of the principal rays 45 is located somewhere between the first reflection surface 12 and the second reflection surface 13 away from the incidence surface 11 and the emission surface 14 inside the optical element configuring the projection system 9. With this, the dirt of the incidence surface 11 and the emission surface 14 due to the particle trap effect by the light can be prevented, so that the image quality of the projection image 3 can be maintained.

Also, in this embodiment, the pencil of rays 40 incident on the light scanning unit 10 is the convergence light 40a, and the converging position 18 of the convergence light 40a itself is inside the projection system 9. With this, the size of the projection system 9 can be further prevented from being increased. Also, each pencil of rays 40 inside the projection system 9 is decreased in size to be isolated, so that the distortion correction of the projection image on each optical surface configuring the projection system 9 becomes easy without deteriorating an image forming characteristic on the projection surface 2. With this, further quality enhancement of the projection image 3 can be achieved.

Also, according to the image formation device 1 of this embodiment, the incident pencil of rays 40 is multiply reflected inside the projection system 9. That is, the optical path of the principal ray 15 in the pencil of rays 40 is folded. For this, the thickness of the projection system 9 can be made smaller, so that the space occupied by the projection system 9 can be reduced. Therefore, the further miniaturization and compactness of the projection system 9 can be achieved.

For example, in the example illustrated in the table 71, a distance d from the emission surface 14 of the projection system 9 to the projection surface 2 (the difference in the z coordinate) is 175 mm. For the description of this embodiment, as described above, a case where the size of the projection image 3 formed on the projection surface 2 is 40 inches is given as an example. Thus, the full lateral width of the projection image 3 (the length in the width direction) W is 885.6 mm, and the full longitudinal width H of the projection image 3 is 498.2 mm. Thus, the throw ratio (d/W) that is the shortening ratio of the projection distance of the image formation device 1 of this embodiment is approximately 0.2.

In the image formation device 1 of the present invention, the throw ratio may be 0.3 or less. Typically, in the case of the image formation device 1 including close-range projection in which the throw ratio is small, the angle of view becomes larger, so that the projection system 9 tends to be larger. However, according to this embodiment, by configuring the optical system 26 as described above, it is possible to achieve the image formation device including ultra-close-range projection having a satisfactory throw ratio of approximately 0.2 without increasing the size of the device.

Also, in this embodiment, the principal ray 15 is allowed to be incident on the mirror surface from the direction having the tilt angle θ2 with respect to the normal line 41 of the mirror surface in the yz plane. That is, the principal ray 15 is allowed to be incident from the direction in which the deflection angle is small. With this, as compared with a case where the principal ray 15 is allowed to be incident from the direction in which the deflection angle is large, the interference of the incidence light and the projection system can be prevented. Also, the incidence angle can be made smaller, so that the distortion correction amount of the projection image 3 can also be reduced. Thus, the quality enhancement of the projection image can be achieved.

Further, in the image formation device 1 of this embodiment, the control device 20 includes the light source controlling unit 22 for correcting the unevenness of the brightness at each projection position of the projection light forming the projection image 3. Also, the control device 20 includes the scanning system controlling unit 23 for correcting the distortion and the color distortion that cannot be completely corrected by the optical system 26. With these configurations, the satisfactory projection image 3 without the unevenness of the brightness and the distortion can be formed.

Also, according to this embodiment, the projection system 9 is achieved by the projection system 9 including the incidence surface 11, the emission surface 14, the first reflection surface 12, and the second reflection surface 13. At this time, the respective surfaces are each an independent optical surface, and thus can each independently perform the aberration correction. With this, the quality enhancement of the projection image 3 acquired can be achieved.

Also, in this embodiment, the projection system 9 includes the single optical element. Therefore, the number of components configuring the projection system 9 becomes minimum. Thus, the space occupied by the projection system 9 can be reduced, so that the miniaturization and lowered cost of the image formation device 1 can be achieved. Also, as compared with the projection system configured of a plurality of optical elements, the deterioration of the quality of the projection image associated with the disposition error of the optical element can be minimized, so that the quality enhancement of the image formation device 1 can be achieved.

Also, from the table 71, the y coordinate of the center of the mirror 28 is 0 mm, and the y coordinate of the center of the projection image 3 is 372.3 mm. Therefore, the y coordinate of the lower side of the projection image 3 (the reference numeral 49 in FIG. 1A) is 123.2 mm.

That is, when the mirror 28 is in the reference state, the intersection point of the normal line passing through the center of the mirror 28 and the projection surface 2 is below the lowest end of the projection image 3. That is, the normal line passing through the center of the mirror 28 passes through the outside of the projection image 3.

Since the image formation device 1 of this embodiment has the above configuration, when for example, the image formation device 1 is disposed on a floor to project an image on a wall surface, the image formation device 1 is not required to be tilted. With this, no legs for tilting the image formation device 1 are required to be provided, which contributes to lowered cost of the device. Also, the convenience of the device user is improved.

The optical performances of the projection image 3 formed by the image formation device 1 of this embodiment will be described below. It should be noted that here, an example of a case where the image size of the projection image 3 is 40 inches (a full lateral width of 885.6 mm×a full longitudinal width of 498.2 mm), and a resolution is 1920 (the x-axis direction)×720 (the y-axis direction), that is, one pixel size is 0.46 mm wide and 0.69 mm long, will be described.

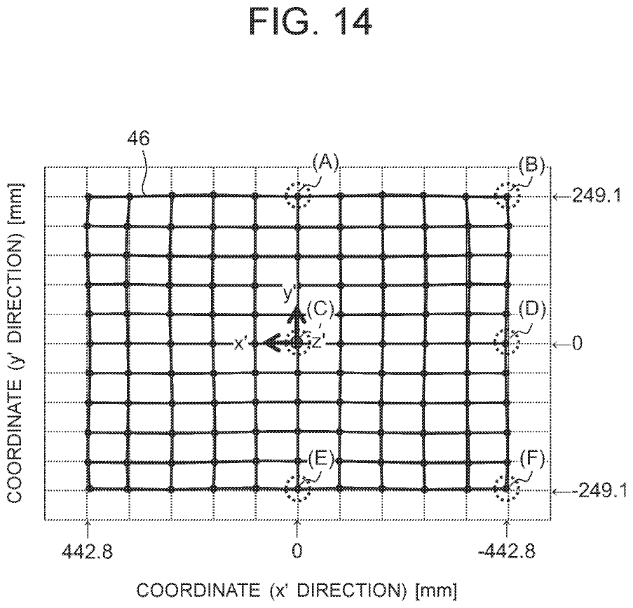

FIG. 14 is a diagram illustrating distortion performances, and illustrates a projection image 46 having a grid pattern formed by the image formation device 1 of this embodiment. Each of the respective grid points of the grid pattern represents an ideal beam position or an actual beam position. A distortion amount dA at each grid point is expressed by (dR−dl)/dl. It should be noted that the dl is the distance from the origin point of the local coordinate system to the grid point at each ideal beam position, and the dR is the distance from the origin point of the local coordinate system to the grid point at each actual beam position.

As illustrated in this drawing, in the image formation device 1 of this embodiment, the distortion amount dA at each grid point of the formed image is held within the range of −2 to 2%.

For example, at the position (B) in FIG. 14, the x′ and y′ coordinates at the ideal beam position are (−442.8, 249.1), and the x′ and y′ coordinates at the actual beam position are (−439.0, 248.3). Therefore, the distortion amount dA is −0.7%. Also, at the position (D), the x′ and y′ coordinates at the ideal beam position are (−442.8, 0), the x′ and y′ coordinates at the actual beam position are (−436.5, 0.1), and the distortion amount dA is −1.4%.

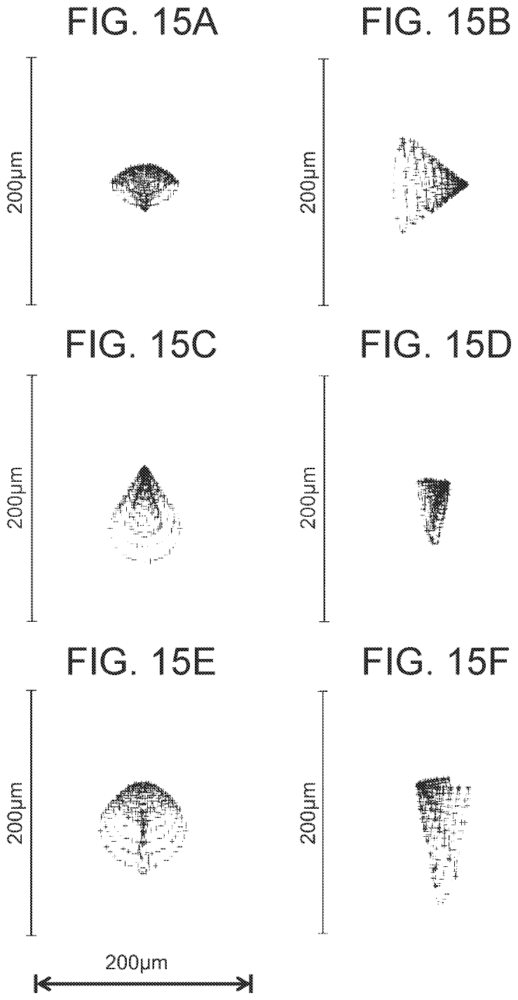

Also, FIG. 15 illustrates the image forming performances of the pencils of rays at the respective positions (A) to (F) of the projection image 3 illustrated in FIG. 14 (a spot diagram). It should be noted that the position (A) is the point of the upper center of the projection image 3, the position (B) is the point of the upper corner of the projection image 3, the position (C) is the point of the center of the projection image 3, the position (D) is the point of the right center of the projection image 3, the position (E) is the point of the lower center of the projection image 3, and the position (F) is the point of the lower corner of the projection image 3. As illustrated in this drawing, according to the image formation device 1 of this embodiment, each pencil of rays is focused to be sufficiently smaller than the one pixel size, and exhibits a satisfactory image forming characteristic.

It should be noted that in this embodiment, the pencil of rays 40 emitted from the light source 25 is transmitted through the pre-scanning optical system 16 as it is, and is guided to the light scanning unit 10. However, for example, a mirror and the like may be disposed somewhere between the light source 25 and the pre-scanning optical system 16. With this, the optical path is folded, so that the optical system can be further compact. Also, the optical element may be added somewhere between the light source 25 and the pre-scanning optical system 16 to shape the beam shape.

Also, likewise, a mirror and the like may be disposed somewhere between the pre-scanning optical system 16 and the light scanning unit 10.

Also, for the description of the embodiment, a case where the projection system 9 is achieved by the single optical element has been given as an example, but the projection system 9 is not limited to this. For example, a plurality of optical elements may be combined to achieve the same function as the projection system 9 of the embodiment. In this case, the intersection point of the optical paths of the respective principal rays is desirably inside any of the optical elements.

In this embodiment, a case where the projection image size is 40 inches has been described, but the image formation device 1 of this embodiment is a so-called laser scanning type projector, and has a focus free characteristic by using a laser beam. Thus, even when the distance from the image formation device 1 to the projection surface is larger than this embodiment and the projection image size is above 40 inches, both the spot size focused onto the projection surface 2 and the pixel size of the projection image 3 become larger, and the projection image 3 without deteriorating the image quality can thus be achieved.

The embodiment is not intended to limit the present invention, and various modifications not departing from the purport of the present invention belong to the technical scope of the present invention.

### REFERENCE SIGNS LIST

1: image formation device, 2: projection surface, 3: projection image, 4: principal ray, 5: principal ray, 6: principal ray, 7: principal ray, 8: principal ray, 9: projection system, 10: light scanning unit, 11: incidence surface, 12: first reflection surface, 13: second reflection surface, 14: emission surface, 15: principal ray, 15a: principal ray, 15b: principal ray, 16: pre-scanning optical system, 17: focusing position, 18: converging position, 19: normal line, 20: control device, 22: light source controlling unit, 23: scanning system controlling unit, 25: light source, 26: optical system, 27: image information device, 28: mirror, 29: first torsion spring, 30: holding member, 31: second torsion spring, 32: holding member, 33B: laser light source, 33G: laser light source, 33R: laser light source, 34B: pencil of rays, 34R: pencil of rays, 35B: lens, 35G: lens, 35R: lens, 36B: pencil of rays, 36G: pencil of rays, 36R: pencil of rays, 37: mirror, 38: color synthesis element, 39: color synthesis element, 40: pencil of rays, 40a: convergence light, 41: normal line, 45: principal ray, 46: projection image, 51: driving waveform, 52: driving waveform, 61: CPU, 62: RAM, 63: ROM, 64: HDD, 65: input I/F, 66: output I/F, 67: bus, 71: table, 72: table

1. An image formation device that forms a projection image by projecting a pencil of rays emitted from a light source onto a projection surface, the image formation device comprising:
a light scanning unit that deflects and reflects the pencil of rays in a first direction and a second direction intersecting with the first direction; and
a projection system that guides the deflected and reflected pencil of rays to the projection surface,
wherein the projection system is configured to allow optical paths of principal rays in each pencil of rays incident on the projection system to mutually intersect at a position between an incidence surface and an emission surface of an optical element that makes up the projection system.

2. The image formation device according to claim 1,
wherein the projection system includes:
a first reflection surface that reflects the pencil of rays incident on the projection system from the incidence surface; and
a second reflection surface that reflects the pencil of rays reflected by the first reflection surface toward the emission surface.

3. The image formation device according to claim 2,
wherein each of the incidence surface, the emission surface, the first reflection surface, and the second reflection surface is an independent surface, and is expressed by a different aspherical polynomial equation.

4. The image formation device according to claim 2,
wherein the projection system is configured so that the optical paths of the principal rays in each pencil of rays incident on the projection system from the incidence surface are intersected at a position between the first reflection surface and the second reflection surface.

5. The image formation device according to claim 1,
wherein the projection system includes the single optical element.

6. The image formation device according to claim 1, further comprising a pre-scanning optical system in which the pencil of rays incident on the light scanning unit is convergence light.

7. The image formation device according to claim 6,
wherein a converging position of the convergence light is inside the projection system.

8. The image formation device according to claim 1,
wherein the light scanning unit includes:
a reflection surface that reflects the inputted pencil of rays; and
a driving unit that allows the reflection surface to make the reciprocating rotational movement in the first direction and the second direction,
wherein when a rotation angle of the reflection surface is zero, an intersection point of a normal line of the reflection surface and the projection surface is outside the projection image.

9. The image formation device according to claim 8,
wherein when a maximum value of a deflection angle of the pencil of rays deflected and reflected in the first direction is larger than a maximum value of a deflection angle of the pencil of rays deflected and reflected in the second direction, the principal ray in the pencil of rays is incident on the light scanning unit from α direction having a predetermined tilt angle with respect to the normal line in a plane determined by the normal line and the second direction when the rotation angle of the reflection surface is zero.

10. The image formation device according to claim 1,
wherein the light scanning unit includes a MEMS (Micro Electro Mechanical Systems) mirror.

11. The image formation device according to claim 1,
wherein when a distance from the emission surface to the projection surface is d and a length in a width direction of the projection image is W, d/W≤0.3.
